(19) United States
(12) Patent Application Publication
(10) Pub. No.: US 2026/0176859 A1
(43) Pub. Date: Jun. 25, 2026

(54) METHOD FOR CATCH BASIN REPAIR USING CFRP (CARBON FIBER REINFORCED POLYMER) AND CFRP-REINFORCED CATCH BASIN

(71) Applicant: Michael Taliercio, Sunbury, OH (US)

(72) Inventor: Michael Taliercio, Sunbury, OH (US)

(21) Appl. No.: 19/432,486

(22) Filed: Dec. 24, 2025

Related U.S. Application Data
(60) Provisional application No. 63/738,749, filed on Dec. 24, 2024.

(51) Int. Cl. E03F 5/04; B29C 73/10; B29C 73/26

(52) U.S. Cl. CPC E03F 5/04; B29C 73/10; B29C 73/26; B29C 2073/262

(57) ABSTRACT

Provided in this disclosure is a method for catch basin repair using CFRP and CFRP-reinforced catch basin, the method including the steps of identifying a catch basin, removing a catch basin drain grate, barricading an area, using a water-resistant building material to replace damaged portions of the catch basin, treating and sealing exposed cracks, treating the interior catch basin surfaces to create a binding surface texture, determining the type of carbon fiber reinforced polymer (CFRP) component to be used, applying epoxy, installing the CFRP component, applying a coating of waterproofing material, and allowing 24 hours for the epoxy and waterproofing material to cure. The CFRP-reinforced catch basin including a drainage inlet, a drain gate, a basin section, a binding surface texture, a CFRP component, a waterproofing material, and drainage outlets.

### I. BACKGROUND

### A. Technical Field

This invention pertains to the field of concrete structure repair and replacement. More particularly, the invention pertains to the field of replacement and reinforcement of concrete catch basins.

### B. Description of Related Art

Catch basins are ubiquitous in the field of public and private water drainage functions. They allow liquid runoff to be collected and redirected away from public and private streets, walkways, buildings, and other structures. However, these basins are semi-permanent fixtures within the aforementioned structures and thus regularly experience wear from exposure to natural elements and consistent use. The basins thus fall into disrepair and often interior walls will collapse, requiring either repair and/or replacement in the event of structural damage, typically in the form of cracks, chipping, etc.

Current means of repairing catch basins involve replacing catch basin rings (if circular), rims (if square), rebuilding old brick-and-mortar by tuck-point or other masonry methods, complete removal & replacement, in full or in part, of damaged basins walls, or simply patching cracks with hydraulic or structural concrete. In cases of complete and total structural failures, basins can either be completely rebuilt with masonry block, formed and poured or with a prefabricated catch basin product.

The traditional replacement/repair option is concrete contractor based, can cost thousands of dollars, take weeks to schedule, install and cure; and is known that it will fail over time due to the porous nature of concrete and the known exposure to water. The current means of repair are costly and temporary solutions to a problem that will never truly go away (i.e., natural wear and tear, freeze and thaw in colder climates). What is needed is a method of repairing a catch basin that also reinforces the structure to resist natural wear and tear and extend the functional lifetime of the repair job and the catch basin as a whole.

### II. SUMMARY

The present invention attempts to resolve the forgoing issues by introducing a unique structure and method of repairing a catch basin that is quick, cost-effective, and which provides reinforcement and resistance to natural wear conditions. The disclosed method allows the catch basin repair to mimic installing a super light-weight, non-corrosive metal tube into the basin so that it may never collapse from normal wear and tear. The process would provide a long-lasting alternative to traditional full replacement or repair of damaged concrete catch basins. This will reduce/eliminate waste materials, reduce need for new concrete (mixed on site or delivered via truck), reduce downtime of work area in parking lot allowing for unencumbered traffic, greatly reduce cure time of materials (concrete can take from 2-4 days for high/early mix) up to 14 days depending on weather conditions and kind of concrete used for the repair. Also, anyone can learn to install this product with a few basic tools, reducing or eliminating the need for a professional concrete contractor to do the installation. If this process is used in new construction catch basins, they may never need to be repaired or replaced. If installed in older catch basins, the process can be accomplished with a few basic tools—saving time, money, collecting bids/estimates, problems with workmanship, materials, etc.

In accordance with an aspect of the present invention, a method of repairing a catch basin including the steps of identifying a catch basin in need of repair, removing a catch basin drain grate and setting the catch basin drain gate aside until repair is complete, barricading an area around the catch basin with cones and caution tape for safety & traffic control, using a water-resistant building material to replace or fill in damaged portions of the catch basin so that interior catch basin surfaces are flat and plumb, and treating and sealing all exposed cracks using the water-resistant building material.

Continued steps in the above method may include treating the interior catch basin surfaces to create a binding surface texture on each of the interior catch basin surfaces, determining the type of carbon fiber reinforced polymer (CFRP) component to be used, applying epoxy to the interior catch basin surfaces, and spreading the epoxy with a spreading tool, ensuring the epoxy is evenly applied over the interior catch basin surfaces. Then, installing the CFRP component inside the catch basin, ensuring the CFRP component adheres to the binding surface texture on each of the interior catch basin surfaces, allowing at least 24 hours for the epoxy to cure without exposure to water/rain and at above 50 degree Fahrenheit temperatures. Then, applying a coating of waterproofing material over the CFRP component after the epoxy has cured, making sure that the waterproofing material extends past the outer edges of the CFRP component and adheres to the surroundings past the interior catch basin surfaces and any portions of the interior catch basin surfaces that extend beneath the CFRP component, ensuring the CFRP component is completely covered and no epoxy is exposed to light or water that will fall into the basin, and allowing 24 hours for the waterproofing material to cure without exposure to water/rain. Finally, replacing the catch basin drain grate, removing any barricades, cones, or caution tape caution tape, and opening the area around the catch basin to traffic.

In accordance with another aspect of the invention, a method of repairing a catch basin, wherein the CFRP component may be a carbon fiber laminate insert or a carbon fiber fabric.

In accordance with another aspect of the invention, a CFRP-reinforced catch basin including a drainage inlet, a drain covering the drainage inlet, a basin section having interior catch basin surfaces, a binding surface texture on each of the interior catch basin surfaces, CFRP component adhered to each of the interior catch basin surfaces via an epoxy, a waterproofing material configured to coat the CFRP component, and drainage outlets.

In accordance with another aspect of the invention, a CFRP-reinforced catch basin, wherein the CFRP component may be a carbon fiber laminate insert or a carbon fiber fabric; which may be determined by the extent of damage of the interior walls of the basin—where walls that cannot be brought to near flat or plumb prior to installation of the CFRP reinforcement may use carbon fiber fabric as a CFRP component option, or in cases wherein a carbon fiber laminate insert will be too rigid for proper adherence.

In accordance with another aspect, the invention describes a method of repairing a catch basin, including steps of applying a water-resistant building material to replace or fill in damaged portions of the catch basin so that interior catch basin surfaces are flat and plumb. Another step includes treating the interior catch basin surfaces to create a binding surface texture on each of the interior catch basin surfaces. Another step includes selecting a suitable type of carbon fiber reinforced polymer (CFRP) component to be used to repair the catch basin. Another step includes applying epoxy adhesive to the interior catch basin surfaces, and spreading the epoxy with a spreading tool, ensuring the epoxy is evenly applied over the interior catch basin surfaces. Another step includes installing a plurality of selected CFRP components inside the catch basin, ensuring the CFRP component adheres to the binding surface texture on each of the interior catch basin surfaces. Another step includes allowing suitable conditions for the epoxy to cure. A step is provided of applying a coating of waterproofing material over the CFRP component after the epoxy has cured, ensuring that the waterproofing material extends past the outer edges of the CFRP component and adheres to the surroundings past the interior catch basin surfaces and any portions of the interior catch basin surfaces that extend beneath the CFRP component. Another step includes ensuring the CFRP component is completely covered and no epoxy is exposed to light or water that will fall into the basin. And a Another step includes allowing suitable conditions for the waterproofing material to cure.

In accordance with another aspect, prior to the step of applying, performing steps of identifying a catch basin in need of repair, removing a catch basin drain grate and setting the catch basin drain gate aside until repair is complete, barricading an area around the catch basin with cones and caution tape for safety and traffic control, and wherein, after the step of ensuring, performing steps of replacing the catch basin drain grate, removing any barricades, cones, or caution tape caution tape, and opening the area around the catch basin to traffic. The step of applying includes treating and sealing all exposed cracks using the water-resistant building material. The steps of allowing suitable conditions include allowing at least 24 hours for the epoxy adhesive and waterproofing material to cure without exposure to water/rain and at a temperature above 50 degrees Fahrenheit. The steps of allowing suitable conditions can alternatively include allowing at least 48 hours for the epoxy adhesive and waterproofing material to cure without exposure to water/rain and at a temperature below 50 degrees Fahrenheit, but still above freezing. The step of treating includes grinding the interior catch basin surfaces with a circular diamond plate grinder to achieve a binding surface texture similar to that of an orange peel, and clearing the interior catch basin surfaces of any loose dust or debris once grinding is complete.

In accordance with another aspect, the step of selecting a CFRP component includes selecting one of a carbon fiber laminate insert for a dry lay-up or a carbon fiber fabric for a wet lay-up. The step of selecting a carbon fiber fabric is performed when the step of applying does not result in surfaces that are flat and plumb. A further step includes applying a second overlapping layer of epoxy adhesive over the carbon fiber fabric once it is installed and adhering to the interior catch basin surfaces such that the overlapping second layer of epoxy adhesive saturates the carbon fiber fabric.

In accordance with another aspect, before the step of applying, a step is performed of drilling one or more holes in the wall. After the step of applying, a step is performed of inserting one or more pins into the respective holes such that an end of each pin protrudes from the wall to provide a structure for receiving and supporting the carbon fiber fabric. The method further includes a step of cutting respective fabric holes in the carbon fiber fabric and pushing the ends of the pins through the fabric holes. A further a step is performed of adding one or more corner pieces over the carbon fiber fabric in each of the corners of the basin to provide additional support to the carbon fiber fabric.

In accordance with another aspect, the step of selecting a suitable type of CFRP component includes selecting a carbon fiber laminate insert, wherein the step of installing comprises placing a plurality of the selected carbon fiber inserts having open-ended sides into the catch basin in an opposing facing configuration, overlapping the open-end sides of the opposing facing inserts by a predetermined amount, securing or affixing the carbon fiber inserts to the interior surfaces of the catch basin following the step of applying the epoxy adhesive, allowing the suitable conditions for the epoxy to cure, and applying a waterproof, membranous coating over the carbon fiber inserts.

In accordance with another aspect, the step of overlapping includes overlapping the opposing facing inserts at least six inches on each open-ended side. The catch basin has a cylindrical configuration and wherein the plurality of carbon fiber inserts includes a pair of facing generally semi-cylindrical inserts each having a periphery configured to overlap by the predetermined amount. Alternatively, the catch basin has a cylindrical configuration and wherein the plurality of carbon fiber inserts includes a pair of vertically stacking cylindrical inserts each having a periphery configured to overlap by the predetermined amount.

In accordance with another aspect, the catch basin has a cuboidal configuration and wherein the plurality of carbon fiber inserts include a pair of facing three-sided, generally semi-cuboidal inserts each having a periphery configured to overlap by the predetermined amount. Alternatively, the catch basin has a cuboidal configuration and wherein the plurality of carbon fiber inserts include a pair of vertically stacking rectangular cuboidal inserts each having a periphery configured to overlap by the predetermined amount.

Other benefits and advantages of this invention will become apparent to those skilled in the art to which it pertains upon reading and understanding of the following detailed specification.

### III. BRIEF DESCRIPTION OF THE DRAWINGS

The disclosed invention may take physical form in certain parts and arrangement of parts, embodiments of which will be described in detail in this specification and illustrated in the accompanying drawings which form a part hereof and wherein:

FIG. 1 is a top section view of a standard square catch basin.

FIG. 2 is a top section view of carbon fiber laminate inserts.

FIG. 3 is a top section view of a standard circular or round catch basin.

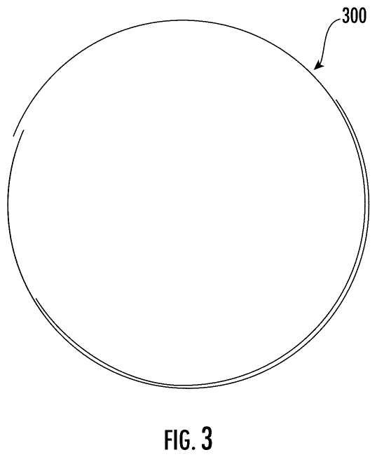

FIG. 4 is a perspective view of a particular embodiment of a carbon fiber laminate insert for a square catch basin.

FIGS. 5A and 5B are exploded perspective views of particular embodiments of a carbon fiber laminate insert incorporated into a square catch basin.

FIGS. 6A and 6B are exploded perspective views of particular embodiments of a carbon fiber laminate insert incorporated into a cylindrical catch basin.

FIG. 7 is an exploded perspective view of a particular embodiment of a carbon fiber laminate insert incorporated into a square catch basin.

FIGS. 8A and 8B are top and side views of the embodiment of a carbon fiber laminate insert incorporated into a square catch basin shown in FIG. 7.

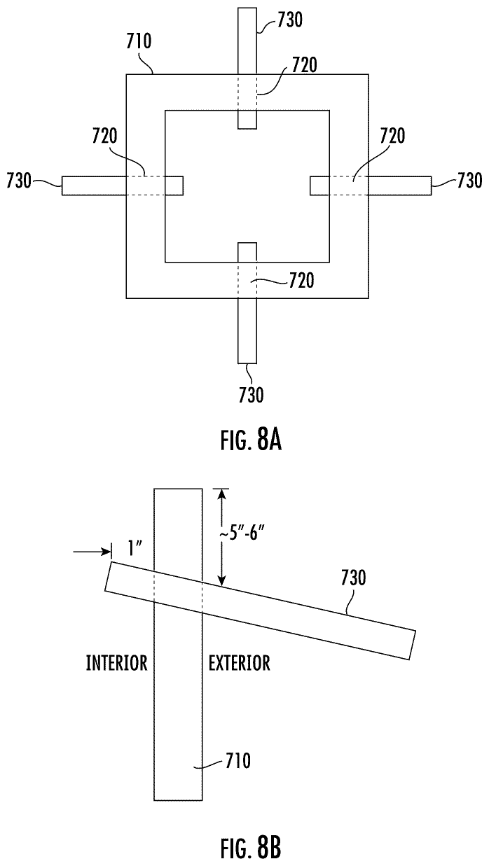

### IV. DETAILED DESCRIPTION

As described further below, the disclosed method may involve repairing and reinforcing a catch basin, which may be cuboid, cylindrical, or any other shape according to the needs and circumstances in which the method is implemented. In a particular, nonlimiting example, a cuboid catch basin may be repaired and reinforced by placing carbon fiber inserts into the catch basin, such that the open-end sides of opposing facing inserts overlap each other by at least 6 inches. A user would secure or affix the carbon fiber inserts to the interior surfaces of the catch basin using an epoxy adhesive. The epoxy would then be allowed to cure, and a waterproof, membranous coating applied over the carbon fiber inserts. In a particular embodiment, the carbon fiber inserts may overlap at least six inches on each open-ended side. In another nonlimiting example, a cylindrical catch basin may be repaired and reinforced using a carbon fiber fabric or carbon fiber laminate installed similarly to the cuboid catch basin example above, which carbon fiber fabric or carbon fiber laminate insert may also overlap at least six inches. Additional carbon fiber laminate inserts or carbon fiber fabric sections may be added as needed to achieve coverage of the interior surfaces of the catch basin, to the desired depth indicated by the depth of the catch basin or the depth of repair needed in the catch basin. In a particular embodiment, each additional CFRP component used to achieve the desired depth may also overlap the previously installed CFRP component layer, vertically, by at least six inches. The vertical direction CFRP component installation may proceed from lower sections of the catch basin to higher sections of the catch basin, or higher to lower, according to the circumstances of the repair and/or reinforcement. In a particular embodiment, as long as the CFRP component is coated with a waterproofing membrane after the CFRP component has cured. In another particular embodiment, the additional carbon fiber inserts, and any inserts used in repairing and reinforcing a cylindrical catch basin, may be circular inserts, with a length at least six inches longer than the circumference of the catch basin to allow for overlap of CFRP component for structural integrity once the CFRP component has cured. In yet another particular embodiment, the CFRP components may include two components per surface section of the catch basin, per depth desired for reinforcement of the catch basins. A catch basin may use one CFRP component or multiple (a multi-piece design).

Referring now to the drawings wherein the showings are for purposes of illustrating embodiments of the article only and not for purposes of limiting the same, and wherein like reference numerals are understood to refer to like components:

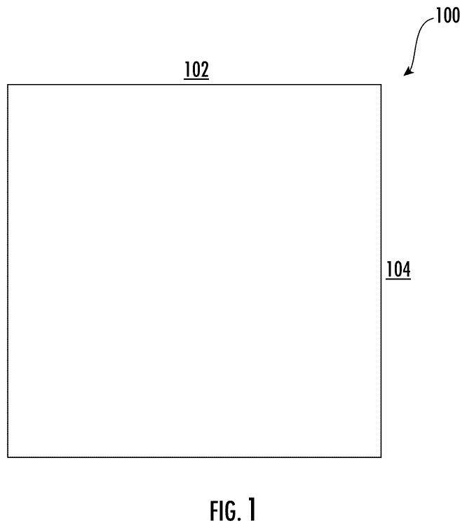

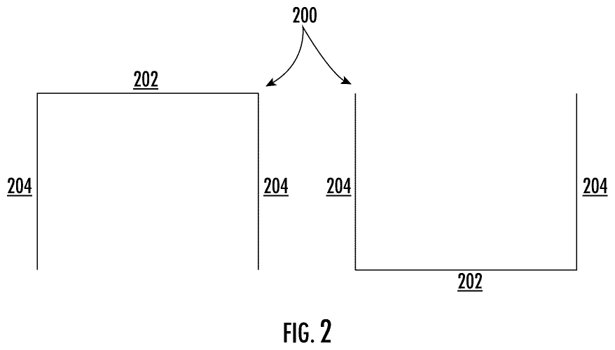

With reference to FIGS. 1, 2, & 3, a catch basin 100, 300 may be repaired and reinforced using carbon fiber reinforced polymer (CFRP) components 200, as described further below. The catch basin 100, 300 may be cuboid (square 100), cylindrical (circular 300), or any other shape according to the needs and circumstances in which the method is implemented. The dimensions of the catch basin may be defined by a first length 102 and a second length 104, which first and second length may be the same length or different length from each other. The CFRP components 200 may be similarly defined by a first length 202 and a second length 204. The CFRP component first lengths 202 may be the same length or different length from the catch basin first 102 or second 104 lengths and the CFRP component second lengths 204 may be six inches longer than the CFRP component first length 202, as described below.

In performing the method disclosed, CFRP components 200 may be physical parts to be installed, adhesive—which may be any adhesive chosen according to sound engineering judgment may be used, but the following embodiments use an exemplary epoxy adhesive—may be used to secure the parts to the inside of the basin surfaces. The total number of CFRP components used may vary based upon the desired depth of repair and/or reinforcement required in each basin, according to the individual circumstances of the repair and/or reinforcement. Once adhered, a waterproof coating may be applied to protect the epoxy from UVA/UVB sunlight and effects of excessive water exposure. In a particular embodiment, the CFRP components 200 may overlap approximately six to eight inches, as described further below. Once the carbon fiber and epoxy have adhered to the interior catch basin surfaces, the system may be up to 10× stronger than four-inch steel, effectively creating a lightweight “metal” reinforcement inside the catch basin that will not allow it to collapse into itself, that is not corrosive, and has a waterproof coating to prevent effects of water exposure. The disclosed method may also be used to reinforce a “new”, or recently installed, catch basin that is not yet damaged to enhance the longevity and structural integrity of the catch basin.

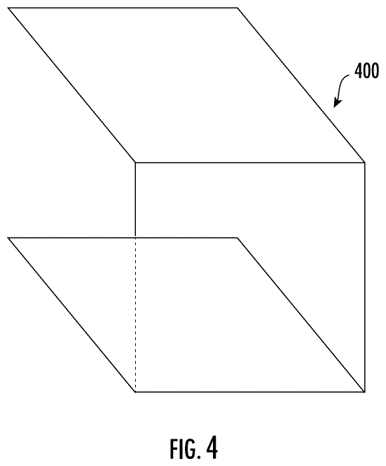

With reference to FIG. 4, a particular embodiment of a carbon fiber laminate insert 400 CFRP component 200 for a square catch basin may be a three-sided piece (shown vertically in FIG. 4, but referenced horizontally per a particular embodiment). The open-ended side may be understood as the side without CFRP materials. In one particular embodiment, using carbon fiber fabric CFRP components for a square catch basin, the carbon fiber fabric pieces may be one to two feet in length, with the components overlapping by at least six inches in a multi-piece design; in a single-piece design using carbon fiber fabric, where the carbon fiber fabric piece may be at least the perimeter of the interior catch basin surfaces of a square catch basin, with the initial piece, and any subsequent pieces installed vertically to address depth of repair needed, overlapping itself by at least six inches horizontally and proceeding components overlap the initial piece by six inches vertically. It should also be understood that a CFRP component for a circular catch basin may be a semi-cylindrical piece—of which two may be used to cover the full circumference of the circular catch basin—or a CFRP component, carbon fiber fabric or carbon fiber laminate inserts as two nonlimiting examples, that is one continuous, cylindrical CFRP component piece. In a multi-piece design for a circular catch basin, when two laminate pieces are used, they may overlap each other by at least 6 inches where the pieces meet on opposite sides of the cylinder.

According to one embodiment of the present invention, the method to repair and reinforce a catch basin may include the following steps:

First, identifying a catch basin in need of repair. Next, removing a catch basin drain grate and setting the catch basin drain gate aside until the repair and reinforcement is complete. The area surrounding the catch basin on the public and private streets, walkways, parking lots, buildings, and any other structures chosen according to sound engineering judgment and containing a catch basin, may be blocked off using barricades, such as cones, caution tape, wooden blockades, or any other tool or structure for cordoning off an area, chosen according to sound engineering judgment, for safety & traffic control.

Next, using a water-resistant building material, such as polyurethane expanding foam, hydraulic cement, caulking, or any other filler material chosen according to sound engineering judgment, to replace or fill in damaged portions of the catch basin, such as broken concrete blocks or poured walls, sealing/filling cracks with sealant, etc., of the catch basin so that the interior catch basin surfaces are flat and plumb (if the basin is a square shape). If necessary, masonry blocks making up a catch basin may be entirely replaced as called-for by the needs of the repair project. If the catch basin is circular, the step may include making the interior catch basin surfaces as smooth as possible, conforming to radius of the internal wall. Any exposed cracks may be similarly treated and sealed using the water-resistant building material. If necessary, continued steps in the method may include treating the interior catch basin surfaces to create a binding surface texture on each of the interior catch basin surfaces. In a particular embodiment, the interior catch basin surfaces may be ground with a circular diamond plate grinder to achieve a binding surface texture similar to that of an orange peel, clearing the interior catch basin surfaces of any loose dust or debris once grinding is complete.

Next, determining the type of CFRP component 200 to be used. In a particular embodiment, where the catch basin is a square shape, the CFRP component 200 may be a carbon fiber laminate insert (dry lay-up), or a carbon fiber fabric (wet lay-up) if better suited for the project (may be best for non-flat surfaces if “flat” cannot be obtained through grinding or by applying a surface course structural product). In another particular embodiment, where the catch basin is a circular shape, carbon fiber fabric may be used for smaller circumference catch basins, while large circumference catch basins may use carbon fiber laminate inserts. Then, applying an adhesive to the interior catch basin surfaces, spreading the epoxy with a spreading tool, such as a flexible plastic putty knife, epoxy roller, or other spreading tool chosen according to sound engineering judgment, ensuring the adhesive is evenly applied over the interior catch basin surfaces. Any adhesive chosen according to sound engineering judgment may be used, but the following embodiments use an exemplary epoxy adhesive. Then, installing the CFRP component 200 inside the catch basin, ensuring the CFRP component 200 adheres to the binding surface texture on each of the interior catch basin surfaces. In a particular embodiment, carbon fiber laminate inserts may overlap with each other by a minimum of six inches, and the epoxy adhesive may be applied to the overlap area of a first carbon fiber laminate insert installed before a second carbon fiber laminate insert is installed. If carbon fiber fabric is used, then a second layer of epoxy adhesive may be applied over the top of the carbon fiber fabric once it is installed and adhering to the interior catch basin surfaces. The overlapping (second) coat of epoxy adhesive may saturate the carbon fiber fabric, using spreading tools again to ensure saturation. The CFRP components 200 may be two separate pieces of laminate or fabric or one continuous piece. In a particular embodiment using two separate pieces of laminate or fabric, the pieces may overlap at least six inches at the point(s) where the pieces meet. Thus, if using two separate pieces of laminate or fabric instead of one continuous piece, an additional six to eight inches may be added to the length of the CFRP component 200 material. A catch basin may also use a combination of different types of CFRP components to achieve coverage of the desired interior catch basin surfaces.

Next, allowing at least 24 hours for the epoxy adhesive to cure without exposure to water/rain and at above 50 degrees Fahrenheit temperatures. If the temperature is below 50 degrees Fahrenheit, but still above freezing (or per epoxy manufacturer's installation temperature recommendation), allowing at least 48 hours for the epoxy adhesive to cure. Then, applying a coating of waterproofing material, which may be any waterproofing sealant or covering chosen according to sound engineering judgment, which may be UVA/UVB reflective or resistant, over the CFRP component 200 after the epoxy adhesive has cured, making sure that the waterproofing material extends past the outer edges of the CFRP component 200 and adheres to the surroundings past the interior catch basin surfaces and any portions of the interior catch basin surfaces that extend beneath the CFRP component 200, ensuring the CFRP component 200 is completely covered and no epoxy is exposed to light—where the light may be UVA/UVB light—or water that will fall into the basin. In a particular embodiment, including a concrete catch basin having a concrete rim or skirt along with the interior catch basin surfaces, a user may ensure that the waterproofing material extends past the outer edges of the CFRP component 200 and adheres to the surrounding concrete rim or skirt and any portions of the interior catch basin surfaces that extend beneath the CFRP component 200. Then, allowing 24 hours for the waterproofing material to cure without exposure to water/rain. Finally, replacing the catch basin drain grate, removing any barricades, cones, or caution tape caution tape, and opening the area around the catch basin to traffic.

The present disclosure also contemplates a pre-made catch basin 100, or a catch basin 100 that is pre-treated using the method described above, prior to installation in public and private streets, walkways, buildings, and other structures. The catch basin 100 may include a drainage inlet, a drain gate covering the drainage inlet, a basin section having interior catch basin surfaces, a binding surface texture on each of the interior catch basin surfaces, a CFRP component 200 adhered to each of the interior catch basin surfaces, a waterproofing material, and drainage outlets. The CFRP component 200 may be adhered via an epoxy, and the waterproofing material may be configured to coat the CFRP component. Prefabricated catch basins may have interior and exterior surfaces treated with CFRP components, which may further include CFRP component treated areas which are coated with UVA/UVB waterproof membrane(s) before installation into parking lot, street, sidewalk, etc.

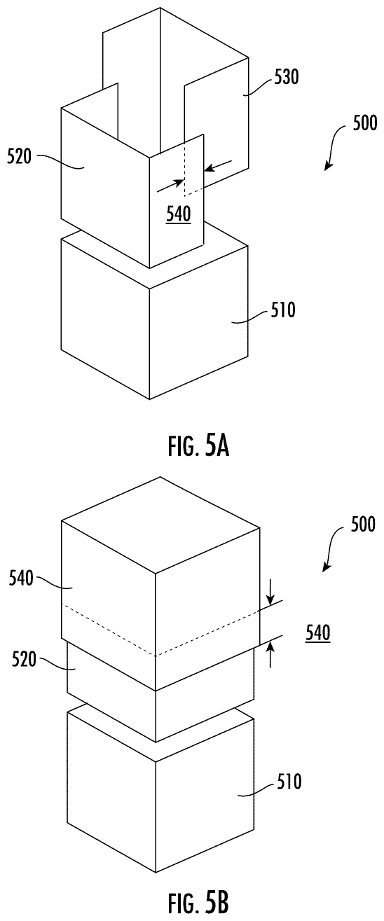

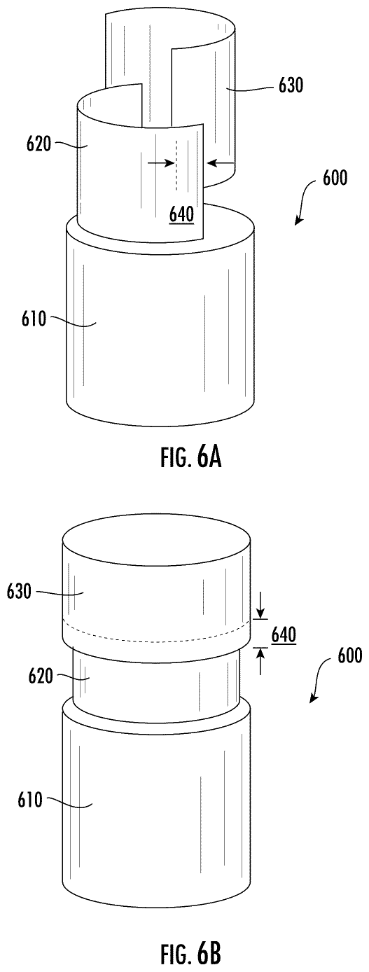

FIGS. 5A, 5B, 6A and 6B depict exploded assembly views 500, 600 of the repaired and lined catch basins 510, 610 in accordance with the present method. The step of selecting a suitable type of CFRP component includes selecting a suitable type of carbon fiber laminate insert 520, 530, 620, 630. The step of installing comprises placing a plurality of the selected carbon fiber inserts 520, 530, 620, 630 having open-ended sides into the catch basin 510, 610 in an opposing facing configuration. The method includes overlapping the open-end sides of the opposing facing inserts by a predetermined amount 540, 640. This step of overlapping includes overlapping the opposing facing inserts at least six inches on each open-ended side. As explained hereinabove, a step is performed of securing or affixing the carbon fiber inserts 520, 530, 620, 630 to the interior surfaces of the catch basin 510, 610 following the step of applying the epoxy adhesive. The steps are then performed of allowing the suitable conditions for the epoxy to cure and applying a waterproof, membranous coating over the carbon fiber inserts.

With specific reference to FIG. 5A, the catch basin 510 has a cuboidal configuration. The carbon fiber inserts are a pair of facing three-sided, generally semi-cuboidal inserts 520, 530 generally comporting with insert 400 described hereinabove, each having a periphery configured to overlap by the predetermined amount 540. Alternatively, as depicted in FIG. 5B, the catch basin 510 has a cuboidal configuration and the plurality of carbon fiber inserts are a pair of vertically stacking rectangular cuboidal inserts 520, 530 each having a periphery configured to overlap by the predetermined amount 540.

With specific reference to FIG. 6A, the catch basin 610 has a cylindrical configuration and the plurality of carbon fiber inserts are a pair of facing generally semi-cylindrical inserts 620, 630 each having a periphery configured to overlap by the predetermined amount 640. Alternatively, as depicted in FIG. 6B, the catch basin 610 has a cylindrical configuration and the plurality of carbon fiber inserts are a pair of vertically stacking cylindrical inserts 620, 630 each having a periphery configured to overlap by the predetermined amount 540.

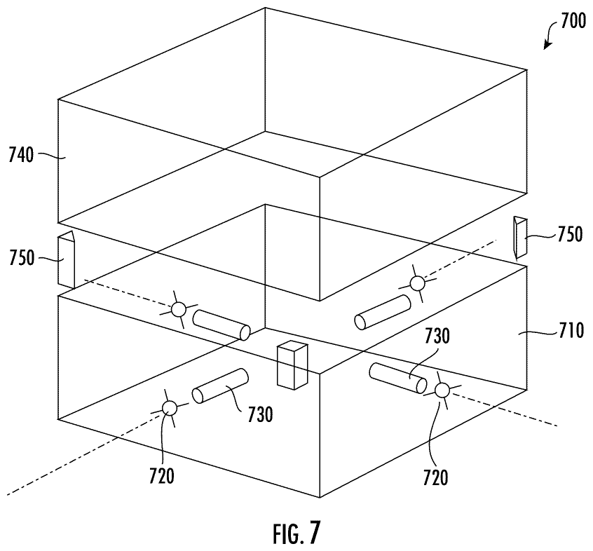

FIG. 7 is a view of a system 700 depicting a repaired and lined catch basin 710 in accordance with a further embodiment. A goal of the present invention is provide a foolproof method that can ensure an effectively sealed catch basin, even if the steps of the method are not properly performed. This foolproof method is implemented by drilling and adding spikes as explained hereinbelow. In this method, on each of the walls of a cuboidal basin 710 (or similarly on the circular walls of a cylindrical basin), one or more holes 720 are drilled through each wall of the basin 710. Into each hole 720 is inserted a fiberglass rebar spike or pin 730. Prior to insertion, epoxy is added to each of the holes 720. The spikes 730 are then inserted into the holes 720 so that they protrude from the walls by approximately one inch. Sheets of fabric 740 are then added to the walls and placed over the spikes 730. Holes can be cut into the fabric 740 so that the spikes 730 can be slid through the fabric 740 so that the fabric 740 can cover over the spikes 730. The purpose of employing the spikes of pins 730 in this manner is done to eliminate the possibility of the wall surface not being properly prepared by promoting adhesion by ensuring that the pins 730 are adhered to the wall and in turn adhered to the fabric 740. In this manner, if there is inadequate adhesion due to faulty installation, the fabric 740 is held in place and does not slip and fall away from the basin wall.

As shown in FIG. 7, a single hole 720 is drilled into each wall of the basin 710, into which a single spike is inserted. This embodiment is particularly useful for basins 710 short in height. For taller basins 710, the holes 720, pins 730, and fabric 740 can represent a first, bottommost row. Additional vertical rows can be added to accommodate the additional height of the basin 740. It is not necessary that holes 720 and pins 730 be included with each additional row. A vertically higher row can include an additional row of fabric 740, overlapped over the top of the first row by six inches as described in greater detail hereinbelow. A further vertically higher row can include holes 720 and pins 730 as can be understood from FIG. 7. In this manner, a taller basin 710 can be lined by consecutive overlapping rows all including fabric 740 but with alternating layers including holes 720 and pins 730. It should be considered that while the illustrated embodiment of FIG. 7 shows row each having a single hole 720 and pin 730, the invention is not limited in this way and a plurality of holes 720 and pins 730 could be employed in any given row and in each row, all without departing from the invention.

In a further embodiment as also depicted in FIG. 7, corner reinforcement members 750 can further employed at each of the corners of the basin 710 to provide additional structural integrity. So after the fabric sheets 740 are applied to each of the four walls of the basin 710 as described hereinabove, the corner pieces 750 are then subsequently added to corners of the basin 710 to provide additional support.

A more detailed method is presented herewith to accompany in the embodiment of FIG. 7, the method includes a preliminary step, performed before the project start date, of checking the weather forecast to plan to have at least four consecutive days of dry weather conditions. Before starting the project, barricade or otherwise mark the work area to provide warning to traffic for safe working conditions. A “Basin Saver Kit” is provided for performing the project. Open the kit to check that all contents are available. The contents should include: six tubes of epoxy resin with 6 detached nozzles; rubber gloves; a plastic spreader, an epoxy resin roller; four 2′×2′ carbon fiber fabric wall pieces 740; four 1′×2′ carbon fiber fabric corner reinforcement pieces 750; four ½″ diameter×6″ carbon fiber re-bar spikes 730; a 2.5 gallon pail of water proofing membrane; and a Basin Saver Warranty badge. The following tools should be available but are not provided with Basin Saver Kit: pressure washer; diamond plate grinder; 12″ painters tray and 12″ paint roller; concrete drill and ½″ drill bit; chalk/marking tool; vacuum or forced air blower; and a hammer.

The method includes steps of removing the catch basin grate (set aside) and preparing the catch basin. This may include tuck pointing missing mortar joints, resetting the rim or replacing loose or damaged concrete blocks. Depending on the quality of the surface, a step is optionally performed of either grinding the inside walls smooth with a circular diamond plate grinder (so that the surfaces have the feel of an orange peel), or pressure washing all wall surfaces. All wall surfaces are to be free of loose debris (moss, oil residue, dirt, grime, etc.) to allow for as much adhesion of the carbon fiber material as possible. Hydraulic cement is preferred for any necessary repairs.

As particularly shown in FIG. 7, a step is performed of installing carbon fiber re-bar spikes or pins 730. Using the concrete drill and a ½″ diameter drill bit, drill one hole 720 in each basin wall approximately 6″ to 12″ from the top of where the carbon fiber fabric 740 will be installed. It's recommended to mark the drill spot with chalk or other marking tool prior to drilling. Drill the hole 720 preferably no more than 5 inches into the basin wall. Choose areas in each wall that appear to be “solid.” The spikes 730 do not need to be uniform in placement. Remove as much concrete dust as possible from each drill site and from inside each hole 720 (vacuum or forced air are easy options to accomplish this). Using the two-cylinder epoxy gun, fill each hole with epoxy resin. Once epoxy resin is each hole 720, insert the re-bar spikes 730 so that they protrude at least 1″ from the basin wall. Tap a spike 730 into the hole 720 with the hammer if necessary. Do not drop the spike 730 if the basin is too deep to retrieve it. Two lengths of rebar pins 730 are included with each kit, 6″ & 18″. If a pin 730 is lost into the wall, just add another pin 730 into the same hole 720 making sure that this one stays protruding approximately 1″ from wall surface.

In a continuance of the method, all four walls are then coated with a layer of structural epoxy resin. Using a two-cylinder epoxy gun, apply resin liberally along each interior basin wall (if circular basin, apply to entire surface all at one time). Evenly spread the resin to cover the entirety of the application area using the plastic spreader provided in the Basin Saver Kit. Be sure to apply resin in each corner. Spread the resin 1″ to 2″ beyond (above and below) the application area to ensure the carbon fiber fabric 740 has resin all around it when applying it in Step 5. Slowly place the carbon fiber fabric 740 uniformly over the catch basin walls that are covered in resin. Place the fabric 740 as uniformly as possible so that the beginning of the top end of the fabric piece 740 is even with the back top end of the fabric piece 740. If done correctly, the bottom of the fabric piece 740 should also match up as well. The fabric 740 should overlap at least 6″ once wrapped around the entire inside of the basin. Do not press the fabric 740 hard into the resin until the desired configuration of the fabric is satisfactory. Once the fabric 740 is uniformly installed, firmly press the fabric 740 into the resin covered walls with your hands (wearing the rubber gloves provided).

In a continuance of the method, either form the fabric 740 around each carbon fiber re-bar spike 730 or cut small holes for each rebar pin 730 then push it through the fabric 740. Both applications are satisfactory. Continue pushing out any air bubbles or creases in the fabric 740 to allow it to adhere to the epoxy resin. Make sure the corners 750 are secured as well. Keep in mind that adhesion of the fabric 740 to the walls is important for a solid installation. If necessary, use the resin roller or plastic spreader to make the fabric 740 “smooth” along the contours of each wall (not all walls will be flat, judgment should be used). Once the fabric 740 is in place, liberally apply another layer of epoxy over the fabric 740. The purpose of this application is to saturate the fabric 740 with the epoxy resin. The fabric 740 is to be saturated with the epoxy resin to give it the strength needed to stop the walls from collapsing. Again, after the epoxy resin is applied over the fabric 740, spread it with the epoxy resin roller or plastic spreader to ensure every fiber of the fabric 740 has been coated. Be certain to apply resin over the covered, or protruding, carbon-fiber re-bar spike 730.

In a further continuance of the method, leave the job site and allow 24-48 hours for the resin to cure and harden, taking into consideration temperature, weather conditions and depth of installation. If resin is tacky when touched with a finger, it needs more time to cure and harden. At the worker's discretion, the work site can remain barricaded or be re-opened to traffic at this time by replacing the basin grate. Once resin has cured and is no longer tacky to the touch, prepare the water proofing membrane material. Pour a portion of the water proofing membrane material into a 12″ painters tray, coat the 12″ painting roller with the water proofing material, then apply the material over the carbon fiber fabric 740. Be sure to apply the water proofing membrane at least 2″-4″ above and below the carbon fiber fabric 740. The carbon fiber itself is inert, but the epoxy is not. The water proofing material should completely coat the fabric so that the fabric 740 cannot be seen at all through the coating. If necessary, apply a second coat.

An additional visit to apply the second coat of water proofing may be needed. Once the water proofing material begins to have a “skin” on its surface it must be allowed to cure until dry before another coat is added. Before the water proofing material dries, write the installation date on the Basin Saver Warranty Badge and firmly place into the water proofing material along the center of any basin wall. The badge should be placed approximately 6″-8″ from driving surface so that it can be seen from above when the grate is in place. An intact Basin Saver Warranty Badge is required for any warranty claims.

The present method is further characterized in an embodiment as described herewith. A Basin Saver catch basin repair system can include a Pre-Project Weather Check in which a technician checks a weather app on a tablet showing a 4-day dry forecast so that before starting a Basin Saver installation, confirm at least four consecutive dry days in the forecast. Moisture-free conditions are critical for proper curing. A worker places barricades and traffic cones around a catch basin on a street. The Basin Saver Kit is opened on-site. A checklist for the kit includes: 4 epoxy resin tubes & nozzles, rubber gloves, a plastic spreader, an epoxy roller; a carbon fiber fabric roll (10′×2′); 4 carbon fiber re-bar spikes; 2.5-gallon waterproofing membrane; a Basin Saver Warranty Badge. Tools not provided include a pressure washer, grinder, drill, roller tray, etc.

For basin preparation, a technician removes the basin grate and cleans inside walls with grinder/pressure washer to prepare the surface. Repairs are made to damaged mortar or concrete using hydraulic cement. Clean or grind the interior walls until smooth and free of debris. For installing carbon fiber re-bar spikes, the technician marks the holes, drills, cleans dust, and inserts spikes with epoxy. Drill one hole per wall, 6 to 12 inches from the top of the carbon fiber application area. Clean out dust, inject epoxy, and insert spikes at least one inch outward from the wall. Spikes can be both straight insertion and optional angled option.

For applying a first epoxy layer, the technician uses two-cylinder epoxy gun and plastic spreader to coat all basin walls. Apply a uniform layer of epoxy resin to all interior surfaces. Extend 1-2 inches beyond the installation area to ensure full coverage. Careful coverage should be performed in corners and edges.

For installing carbon fiber fabric, the technician unrolls carbon fiber fabric into basin, aligning and smoothing it into place with gloved hands. The carbon fiber fabric is wrapped evenly along the basin walls, overlapping at least 6 inches, formed around or punctured through the re-bar spikes, smoothing out air bubbles and wrinkles. For saturating the fabric with epoxy, the technician applies and rolls epoxy over the carbon fiber fabric. The carbon fiber fabric is fully saturated with a second layer of epoxy resin to ensure all fibers and spikes are coated for maximum strength.

For the curing period, the work zone is barricaded overnight through day-to-night transition. The resin is allowed 24-48 hours to cure and harden. Curing time may vary based on weather and temperature. The technician tests tackiness with a gloved finger. When the surface is no longer tacky, proceed to the step of applying the waterproofing membrane. The technician uses roller and paint tray to apply waterproofing membrane to interior walls. The waterproofing membrane is applied over the carbon fiber area, extending 2-4 inches above and below the fabric. A second coat is applied if necessary. The first coat can be semi-transparent and the second coat fully opaque.

For the installing the warranty badge, the technician writes the date on the badge and presses it into wet waterproofing near top of basin wall. Before the waterproofing dries, the installation date is marked and the Basin Saver Warranty Badge is affixed approximately 6-8 inches below the surface. The badge is placed to be visible through the grate. Project Completion is when the technician replaces the grate and removes the barricades. The Basin Saver system restores structural integrity and extends the life of the catch basin, ready for years of service.

The present method is further characterized in an embodiment having steps as described herewith. In a Pre-Project Weather Check, a technician checks weather forecast on phone/tablet showing 4 dry days. “Before starting your Basin Saver installation, confirm at least four consecutive dry days in the forecast.” Moisture-free conditions are critical for proper curing.
1. Safety First: Worker places cones and barricades around a street basin. “Barricade or mark the work area to ensure safe working conditions for both workers and traffic.” PPE includes hard hat, gloves, reflective vest.
2. Unpack the Basin Saver Kit and confirm all contents are included.
3. Basin Preparation: Remove basin grate. Technician grinds or pressure washes interior walls. “Remove the grate and prepare the basin. Repair cracks or missing mortar, then clean or grind walls until smooth and debris-free.” “Before” (dirty) vs. “After” (clean, orange-peel texture).
4. Install Carbon Fiber Re-bar Spikes: Mark drill spots, drill, clean holes, inject epoxy, insert spikes. “Drill one hole per wall, 6-12 inches from the top of the carbon fiber area. Clean out dust, inject epoxy, and insert spikes at least 1 inch outward.” Use chalk marks. Avoid drilling deeper than 5″. Vacuum cleaning of the holes.
5. Apply First Epoxy Layer: Technician uses epoxy gun and spreader to coat walls. “Apply a uniform layer of epoxy resin to all interior walls, extending 1-2 inches beyond the repair area for full coverage.” Even spreading in corners. Smooth texture.
6. Install Carbon Fiber Fabric: Worker applies carbon fiber fabric over epoxy-coated surface, aligning edges. “Wrap the carbon fiber fabric evenly along the walls, overlapping at least 6 inches. Form around or puncture through the re-bar spikes. Smooth out bubbles and wrinkles.” Gloved hands pressing and smoothing fabric, overlap seam.
7. Saturate Fabric with Epoxy: Apply second epoxy coat over fabric using roller. “Fully saturate the carbon fiber with a second epoxy layer. Ensure all fibers and re-bar spikes are coated for maximum strength.” Glossy finish appears as resin cures.
8. Curing Period: Site is barricaded site from day to night. Worker tests surface for tackiness. “Allow 24-48 hours for resin to cure. Curing time varies by weather. If tacky, allow more time before proceeding.” Cure time: 24-48 hrs.
9. Apply Waterproofing Membrane: Technician rolls waterproofing onto basin walls using painter's tray and roller. “Apply waterproofing membrane over the carbon fiber area, extending 2-4 inches above and below the fabric. Apply a second coat if necessary.” First coat semi-transparent; second coat fully opaque.
10. Install Warranty Badge: Technician writes date on badge and presses into wet waterproofing. “Before the waterproofing dries, mark the installation date and affix the Basin Saver Warranty Badge 6-8 inches below surface level, visible through the grate.” Warranty Required for Claims.
11. Project Completion: Worker replaces grate, removes barricades. “The Basin Saver system restores structural integrity and extends the life of your catch basin—ready for years of reliable service.” Basin Saver—Reinforce. Protect. Preserve.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed:

1. A method of repairing a catch basin, comprising steps of:
applying a water-resistant building material to replace or fill in damaged portions of the catch basin so that interior catch basin surfaces are flat and plumb;
treating the interior catch basin surfaces to create a binding surface texture on each of the interior catch basin surfaces;
selecting a suitable type of carbon fiber reinforced polymer (CFRP) component to be used to repair the catch basin;
applying epoxy adhesive to the interior catch basin surfaces, and spreading the epoxy with a spreading tool, ensuring the epoxy is evenly applied over the interior catch basin surfaces; installing a plurality of selected CFRP components inside the catch basin, ensuring the CFRP component adheres to the binding surface texture on each of the interior catch basin surfaces;
allowing suitable conditions for the epoxy to cure;
applying a coating of waterproofing material over the CFRP component after the epoxy has cured, ensuring that the waterproofing material extends past the outer edges of the CFRP component and adheres to the surroundings past the interior catch basin surfaces and any portions of the interior catch basin surfaces that extend beneath the CFRP component;
ensuring the CFRP component is completely covered and no epoxy is exposed to light or water that will fall into the basin; and
allowing suitable conditions for the waterproofing material to cure.

2. The method of claim 1, wherein, prior to the step of applying, performing steps of:
identifying a catch basin in need of repair;
removing a catch basin drain grate and setting the catch basin drain gate aside until repair is complete;
barricading an area around the catch basin with cones and caution tape for safety and traffic control; and
wherein, after the step of ensuring, performing steps of replacing the catch basin drain grate, removing any barricades, cones, or caution tape caution tape, and opening the area around the catch basin to traffic.

3. The method of claim 1, wherein the step of applying comprises treating and sealing all exposed cracks using the water-resistant building material.

4. The method of claim 1, wherein the steps of allowing suitable conditions comprise allowing at least 24 hours for the epoxy adhesive and waterproofing material to cure without exposure to water/rain and at a temperature above 50 degrees Fahrenheit.

5. The method of claim 1, wherein the steps of allowing suitable conditions comprise allowing at least 48 hours for the epoxy adhesive and waterproofing material to cure without exposure to water/rain and at a temperature below 50 degrees Fahrenheit, but still above freezing.

6. The method of claim 1, wherein the step of treating comprises grinding the interior catch basin surfaces with a circular diamond plate grinder to achieve a binding surface texture similar to that of an orange peel, and clearing the interior catch basin surfaces of any loose dust or debris once grinding is complete.

7. The method of claim 1, wherein the step of selecting a CFRP component comprising selecting one of a carbon fiber laminate insert for a dry lay-up or a carbon fiber fabric for a wet lay-up.

8. The method of claim 7, wherein the step of selecting a carbon fiber fabric is performed when the step of applying does not result in surfaces that are flat and plumb.

9. The method of claim 8, further comprising a step of applying a second overlapping layer of epoxy adhesive over the carbon fiber fabric once it is installed and adhering to the interior catch basin surfaces such that the overlapping second layer of epoxy adhesive saturates the carbon fiber fabric.

10. The method of claim 8, wherein, before the step of applying, performing a step of drilling at least one hole in the wall, and wherein, after the step of applying, inserting at least one pin into the respective hole such that an end of the pin protrudes from the wall to provide a structure for receiving and supporting the carbon fiber fabric.

11. The method of claim 10, further comprising a step of cutting at least one fabric hole in the carbon fiber fabric and pushing the end of the pin through the fabric hole.

12. The method of claim 8, further comprising a step of adding at least one corner piece over the carbon fiber fabric in each of the corners of the basin to provide additional support to the carbon fiber fabric.

13. The method of claim 7, wherein the step of selecting a suitable type of CFRP component comprises:
selecting a carbon fiber laminate insert, wherein the step of installing comprises placing a plurality of the selected carbon fiber inserts having open-ended sides into the catch basin in an opposing facing configuration;
overlapping the open-end sides of the opposing facing inserts by a predetermined amount;
securing or affixing the carbon fiber inserts to the interior surfaces of the catch basin following the step of applying the epoxy adhesive;
allowing the suitable conditions for the epoxy to cure; and
applying a waterproof, membranous coating over the carbon fiber inserts.

14. The method of claim 13, wherein the step of overlapping comprises overlapping the opposing facing inserts at least six inches on each open-ended side.

15. The method of claim 13, wherein the catch basin has a cylindrical configuration and wherein the plurality of carbon fiber inserts comprise a pair of facing generally semi-cylindrical inserts each having a periphery configured to overlap by the predetermined amount.

16. The method of claim 13, wherein the catch basin has a cylindrical configuration and wherein the plurality of carbon fiber inserts comprise a pair of vertically stacking cylindrical inserts each having a periphery configured to overlap by the predetermined amount.

17. The method of claim 13, wherein the catch basin has a cuboidal configuration and wherein the plurality of carbon fiber inserts comprise a pair of facing three-sided, generally semi-cuboidal inserts each having a periphery configured to overlap by the predetermined amount.

18. The method of claim 13, wherein the catch basin has a cuboidal configuration and wherein the plurality of carbon fiber inserts comprise a pair of vertically stacking rectangular cuboidal inserts each having a periphery configured to overlap by the predetermined amount.
